(19) United States
(12) Patent Application Publication
(10) Pub. No.: US 2026/0175404 A1
(43) Pub. Date: Jun. 25, 2026

(54) COLLABORATIVE MOBILE ROBOT

(71) Applicant: Dubai Future Foundation, Dubai (AE)

(72) Inventors: Tanzim Ahmed, Dubai (AE); Julian Ferling, Dubai (AE); Mohammad Alhareb, Dubai (AE); Tarek Taha, Dubai (AE); Khalifa Alqama, Dubai (AE); Chien-Ming Tseng, Dubai (AE)

(73) Assignee: Dubai Future Foundation, Dubai (AE)

(21) Appl. No.: 19/426,320

(22) Filed: Dec. 19, 2025

Related U.S. Application Data
(60) Provisional application No. 63/737,061, filed on Dec. 20, 2024.

(51) Int. Cl. B25J 9/00; B25J 5/00; B25J 19/00; B25J 19/02; B25J 19/06

(52) U.S. Cl. CPC B25J 9/0009; B25J 5/007; B25J 19/0025; B25J 19/005; B25J 19/0054; B25J 19/023; B25J 19/063

(57) ABSTRACT

A collaborative mobile robot with several enhanced design features is disclosed. In an embodiment, a collaborative mobile robot comprises: a chassis, and a retractable electronic unit that is retractably coupled with the chassis. The retractable electronic unit comprises: an electronic unit housing supporting one or more electrical components; a cable enclosure housing one or more electrical cables coupled to the one or more electrical components; and one or more telescopic rails coupled to the chassis and supporting the electronic unit housing thereon.

### CROSS-REFERENCE TO RELATED APPLICATIONS

This application claims priority to and the benefit of U.S. Provisional Patent Application No. 63/737,061, filed on Dec. 20, 2024, the entire contents of which is hereby incorporated by reference herein for all purposes.

### TECHNICAL FIELD

The present disclosure relates to a collaborative mobile robot (CMR) design.

### BACKGROUND

The rapid growth of automation in industrial environments has created a significant demand for mobile robots that can operate flexibly, reliably, and with minimal downtime. Traditional mobile robots are often constrained by rigid architectures that require substantial time and labor to modify, service, or adapt to new tasks. In fast-paced environments like manufacturing or logistics, such delays can lead to considerable inefficiencies and productivity losses. Hence, there is an increasing need for robots that not only provide the versatility to handle multiple tasks but also simplify maintenance and increase operational uptime.

Accordingly, an additional, alternative, and/or improved mobile robot remains highly desirable.

### SUMMARY

In accordance with one aspect of the present disclosure, a collaborative mobile robot is disclosed, comprising: a chassis; and a retractable electronic unit that is retractably coupled with the chassis, the retractable electronic unit comprising: an electronic unit housing supporting one or more electrical components; a cable enclosure housing one or more electrical cables coupled to the one or more electrical components; and one or more telescopic rails coupled to the chassis and supporting the electronic unit housing thereon.

In some aspects, the retractable electronic unit comprises an upper tier and a lower tier, wherein the upper tier and lower tier are separated by a structural mounting plate.

In some aspects, the upper tier is configured as a logic, communication, and power distribution layer of the retractable electronic unit.

In some aspects, the lower tier is configured as a motor drive and interface layer.

In some aspects, the structural mounting plate provides a conductive heat path from the one or more electrical components to the chassis.

In some aspects, the one or more telescopic rails enable extension of the retractable electronic unit up to a predefined travel distance.

In some aspects, the cable enclosure comprises a plurality of linkages and is arranged at a periphery of the electronic unit housing to minimize cable stress.

In some aspects, the one or more electrical components comprise: a motor controller, a robot computer, and/or a safety programmable logic controller.

In some aspects, the collaborative mobile robot further comprises a replaceable battery module.

In some aspects, the chassis comprises one or more removable side doors.

In some aspects, the collaborative mobile robot further comprises a drive system coupled to the chassis, the drive system comprising: a plurality of drive wheels, each drive wheel mounted on a rocker; a plurality of caster wheels, each associated with a respective drive wheel, with each caster wheel mounted to the rocker of the respective drive wheel; and a drive motor coupled to each of the plurality of drive wheels

In some aspects, the drive system further comprises a plurality of caster wheels mounted to a second rocker.

In some aspects, the plurality of drive wheels are arranged at a first side of the chassis, and the plurality of caster wheels mounted to the second rocker are arranged at a second side of the chassis opposite the first side.

In some aspects, the collaborative mobile robot further comprises one or more external attachment ports and/or service ports provided in the chassis.

In some aspects, the collaborative mobile robot further comprises one or more emergency stop switches.

In some aspects, the collaborative mobile robot further comprises one or more corner bumpers.

In some aspects, the collaborative mobile robot further comprises a three-dimensional camera.

In some aspects, the collaborative mobile robot further comprises a laser scanner.

In some aspects, the collaborative mobile robot further comprises a wireless charging unit arranged at a bottom of the chassis.

### BRIEF DESCRIPTION OF THE DRAWINGS

Further features and advantages of the present disclosure will become apparent from the following detailed description, taken in combination with the appended drawings, in which:

FIGS. 1A and 1B show top and bottom perspective views respectively of a collaborative mobile robot in accordance with the present disclosure;

FIGS. 2A-C show a retractable electronic unit of the collaborative mobile robot;

FIG. 3 shows a replaceable and swappable battery module of the collaborative mobile robot;

FIGS. 4A and 4B show front and rear perspective views respectively of a rocker-based mobility system of the collaborative mobile robot;

FIG. 5 shows external attachment ports and service ports of the collaborative mobile robot;

FIG. 6 shows emergency safety features of the collaborative mobile robot;

FIG. 7 shows corner bumpers of the collaborative mobile robot;

FIGS. 8A and 8B show removable side panels of the collaborative mobile robot;

FIG. 9 shows a representation of a field of view for 3D cameras of the collaborative mobile robot; and

FIG. 10 shows a representation of 360° coverage of safety laser scanners of the collaborative mobile robot.

It will be noted that throughout the appended drawings, like features are identified by like reference numerals.

### DETAILED DESCRIPTION

The present disclosure describes a highly adaptable and universal base robotic platform, a Collaborative Mobile Robot (CMR), designed for industrial automation. With an emphasis on ease of maintenance, multiple task execution, and operational efficiency, the CMR system addresses the limitations of traditional robots, which often require extensive downtime for reconfiguration or repairs. The CMR stands out with its modular design that is built to handle different industrial tasks seamlessly while ensuring safety and minimizing operational interruptions.

To allow for simplified maintenance and increased operational uptime, the CMR provides a versatile platform that integrates one or more superior design features, such as retractable electronics for easy servicing, a swappable battery module for prolonged usage, a rocker-based mobility system that enhances maneuverability on varied surfaces, in addition to various other features, as described in more detail below.

With these capabilities, the CMR is poised to transform industries that require flexible and efficient robotic solutions. Accordingly, the CMR offers a forward-thinking solution for industries that demand flexible, modular, and service-friendly robotics. With features that prioritize easy maintenance, enhanced safety, and seamless task adaptability, the CMR can help to revolutionize industrial automation, providing unmatched versatility in a variety of dynamic environments.

In accordance with the present disclosure, a collaborative mobile robot with several enhanced design features is disclosed. In at least one embodiment, a collaborative mobile robot comprises: a chassis, and a retractable electronic unit that is retractably coupled with the chassis. The retractable electronic unit comprises: an electronic unit housing supporting one or more electrical components; a cable enclosure housing one or more electrical cables coupled to the one or more electrical components; and one or more telescopic rails coupled to the chassis and supporting the electronic unit housing thereon.

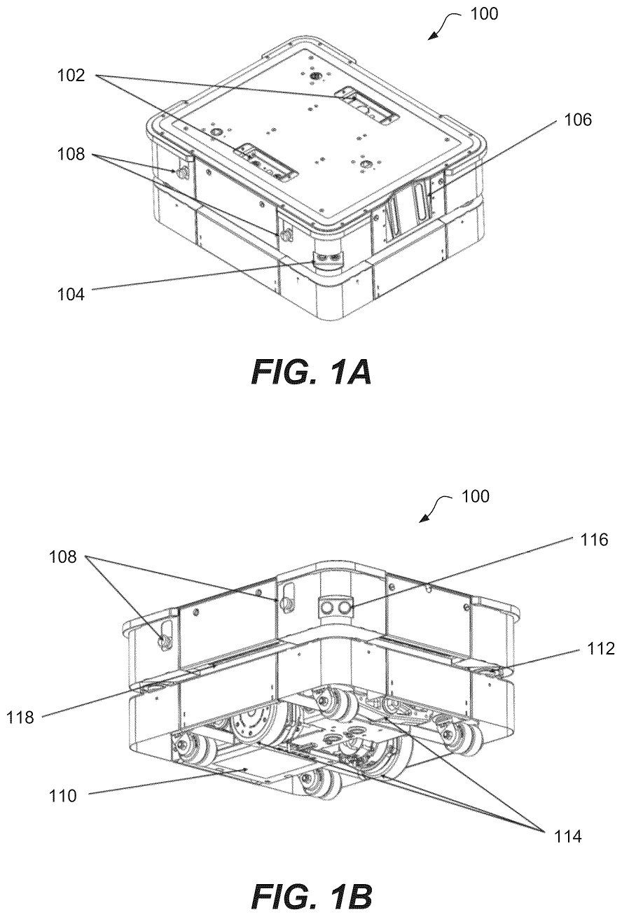

Embodiments are described below, by way of example only, with reference to FIGS. 1A-10.

FIGS. 1A and 1B show top and bottom perspective views respectively of a collaborative mobile robot (CMR) 100 in accordance with the present disclosure. In particular, FIGS. 1A and 1B provide a comprehensive external view of an example of the CMR 100.

The top view of the CMR 100 as shown in FIG. 1A highlights several components, including external attachment ports 102 that enable integration with additional hardware or tools, service ports 104 that allow for diagnostics and communication, and a 3D camera module 106 that enhances visual awareness and navigation. Also visible are emergency stop switches 108 on each corner of the CMR 100, providing easy access for operators to halt the robot if necessary.

The bottom view of the CMR 100 as shown in FIG. 1B showcases a wireless charging unit 110, which enables the robot to recharge without manual intervention. Additionally, safety laser scanners 112 are located in the corners, offering 360-degree obstacle detection for safe navigation. Drive train units 114, and a power switch 116 and status light 118 are also clearly visible, demonstrating the robot's operational features.

As evidenced from the various features and components shown in FIGS. 1A and 1B, the CMR 100 is designed to address the growing demand for highly flexible, easily serviceable, and modular robots capable of performing multiple tasks in dynamic industrial environments. The modular design of the CMR allows for easy adaptation to various industrial tasks, from material handling to precision assembly, while maintaining a focus on safety, efficiency, and ease of maintenance. It will be appreciated that a CMR in accordance with the present disclosure may not have all the features shown in FIGS. 1A and 1B. That is, a CMR may have only some of the features shown in FIGS. 1A and 1B, such as one or more of the features shown in FIGS. 1A and 1B, which each provide advantageous capabilities.

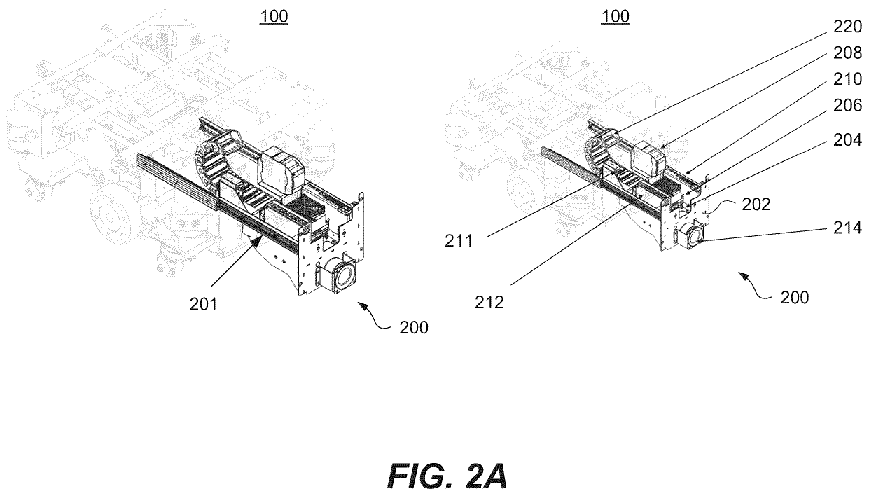

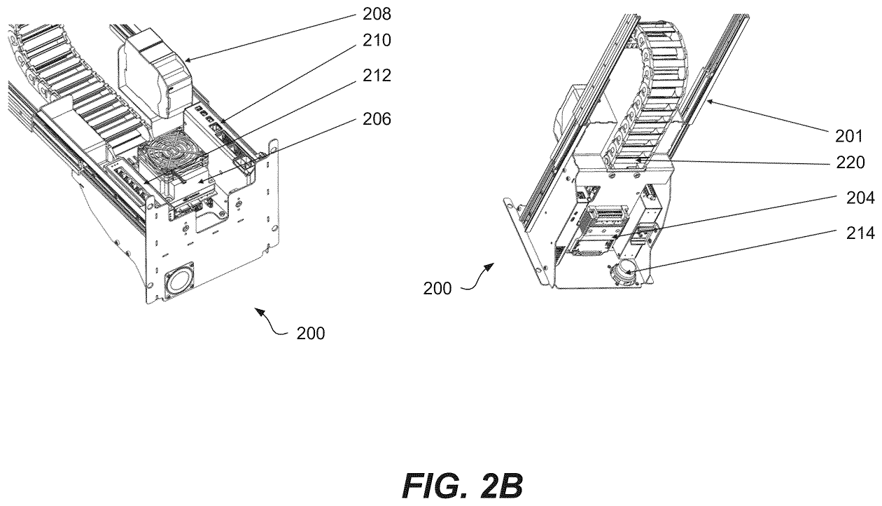

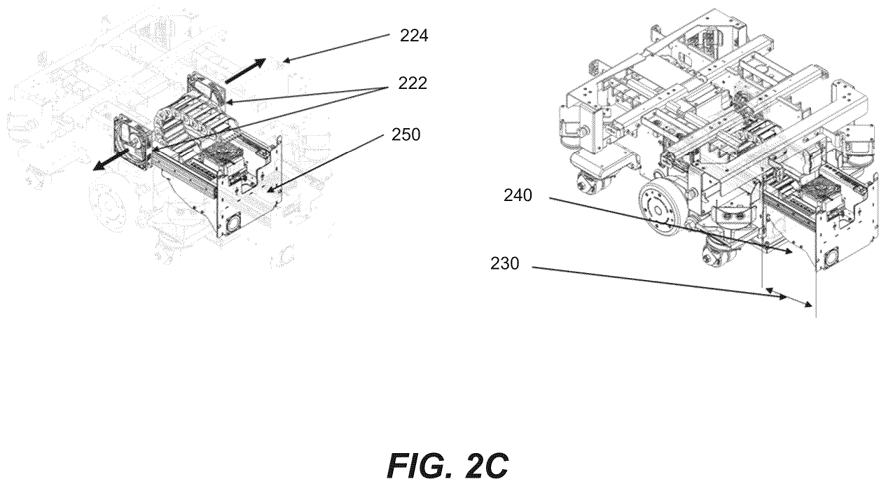

FIGS. 2A-C show a retractable electronic unit 200 of the CMR 100. External panels of the CMR 100 are removed in FIGS. 2A-C to show the retractable electronic unit with respect to the chassis of the CMR. The CMR's electronic unit 200 is housed on a sliding, telescopic rail system, enabling easy access for maintenance, repairs, or component replacement. The entire unit can be retracted from the chassis for quick servicing, allowing technicians to replace or troubleshoot electronics without the need to disassemble the robot. This modular electronic unit 200 is designed to reduce maintenance time, ensuring that the robot can be quickly serviced and returned to operation. FIG. 2A provides two views of the same retractable electronic unit 200 of the CMR 100 for ease of reference-a first view (on the left-hand side) that indicates just the electronic unit 200 and telescopic rails 201, and a second view (on the right-hand side) that indicates various components of the electronic unit 200.

As seen in FIG. 2A, the electronic unit 200 is supported on one or more telescopic rails 201 that are coupled to the chassis of the CMR 100 and can be fully retracted from the chassis, allowing quick and easy access for repairs or component replacements. The electronic unit 200 has a housing 202 that supports one or more electronic components, such as a motor controller 204, a robot computer 206, and/or a safety programmable logic controller 208. Also shown is a power distribution unit 210, a USB hub 211, and an Ethernet hub 212. A speaker 214 may also be provided.

A cable enclosure 220 or energy chain houses one or more electrical cables coupled to the one or more electrical components and that are coupled to other areas of the CMR 100. As depicted in FIG. 2A, the cable enclosure 220 comprises a plurality of linkages to accommodate movement of the electronic unit 200.

Accordingly, the electronic unit 200, including the electronic unit housing 202 supporting one or more electrical components, the cable enclosure 220, and the telescopic rail(s) 201, is retractable and each of the electrical components of the electronic unit 200 can be serviced or replaced without disassembling other parts of the robot. This design advantageously reduces downtime and ensures operational continuity.

In embodiments herein, the retractable electronic unit 200 is separated into two tiers. FIG. 2B shows an upper tier configuration (left hand side) and a lower tier configuration and slide mechanism (right hand side) of the electronic unit 200. As further shown in FIG. 2B, the retractable electronic unit 200 employs a dual-tier modular architecture housed within a precision sliding rail mechanism, enabling systematic component access and functional segregation of electronic subsystems. The entire assembly may be configured as a drawer-style retractable unit with a defined (e.g. 300 mm) extension travel, capable of full extraction from the robot chassis for maintenance operations.

As shown in FIG. 2B, in embodiments herein the electronic unit is organized into two functionally distinct tiers, separated by a structural mounting plate that provides mechanical rigidity, electromagnetic shielding, and thermal barrier properties. This vertical stratification enables independent access to either tier without requiring removal of components from the opposing tier, significantly reducing maintenance complexity and downtime. The left-hand side of FIG. 2B is an isometric view showing the upper tier component layout including Safety PLC, Power Distribution Unit, Ethernet Hub, and Robot Computer. The centralized power distribution architecture enables efficient routing to both logic components and lower tier motor controller. The energy chain and slide mechanism are also visible. The right-hand side of FIG. 2B is a view illustrating the precision slide rail system, lower tier components including motor controller mounting location, speaker, and energy chain routing. The slide mechanism enables extension travel of a defined travel distance (e.g. 300 mm) for enabling complete field serviceability.

Referring to the left-hand side of FIG. 2B, the first tier (upper surface) of the retractable electronic unit 200 is configured to provide a logic, communication, and power distribution layer. The upper tier in this exemplary configuration houses all logic-level electronics, communication systems, and centralized power distribution infrastructure, including the robot computer 206, safety programmable logic controller (PLC) 208, Ethernet hub 212, and power distribution unit 210.

This strategic consolidation of control and distribution systems provides several architectural advantages, including but not limited to: centralized power distribution with short, direct routing to lower tier motor controller; physical and electrical isolation of logic circuits from high-current switching noise; superior accessibility for software diagnostic procedures, and safety verification; reduced electromagnetic interference (EMI) on sensitive digital circuits through spatial separation from motor drive electronics; and natural convective cooling path in the cooler ambient air region above heat-generating motor controller.

The robot computer 206 may occupy the central position within the upper tier, facilitating balanced cable routing to peripheral systems throughout the robot. The safety PLC 208 maintains spatial separation per functional safety standards (e.g. ISO 13849-1) while remaining readily accessible for safety circuit verification and maintenance. The power distribution unit 210 acts as the central power management node, receiving primary power from the energy chain and distributing regulated voltages to all electronic subsystems. The Ethernet hub 212 provides network connectivity, with all communication interfaces terminating at the tier edge for ergonomic cable connection during maintenance operations.

The placement of the power distribution unit 210 in the upper tier, rather than with motor drive electronics, offers distinct advantages, including but not limited to: power distribution circuits operate at significantly lower current levels than motor drive stages; heat generation from distribution electronics is minimal compared to motor controller switching losses; central location enables optimized cable routing to both upper tier logic components and lower tier power electronics; and accessibility for power distribution troubleshooting and modification without disturbing high-power motor drive systems.

Referring to the right-hand side of FIG. 2B, the second tier (lower surface) of the retractable electronic unit 200 is configured to provide a motor drive and interface layer. The lower tier in this exemplary configuration accommodates high-power motor drive electronics, electromechanical interfaces, and audio signaling systems, including the motor controller 204, energy chain interface/cable enclosure 220, and speaker 214. The strategic placement of motor drive electronics on the lower tier provides various benefits including: optimal weight distribution with the heaviest component positioned at the base; direct thermal coupling to chassis structure for heat dissipation from motor controller power stages; minimized high-current cable runs between motor controller and drive motors, reducing voltage drop, power loss, and radiated EMI; isolation of switching noise from motor drives away from sensitive logic circuits; and access to chassis-level thermal management infrastructure.

The motor controller 204 occupies the central position within the lower tier, enabling symmetrical power distribution to the robot's drive motors through short, heavy-gauge conductors. Heat dissipation is accomplished through mounting interface contact with the chassis structure, which acts as an extended heat sink. The motor controller's power semiconductor devices (IGBTs or MOSFETs) are thermally bonded to mounting surfaces that conduct heat directly to the chassis framework.

The energy chain/cable enclosure 220 connection point is strategically located at the tier periphery to minimize cable stress during the retraction travel and maintain appropriate bend radius requirements throughout the operational envelope. The speaker 214 is positioned for acoustic clarity while remaining protected within the tier structure.

The retractable electronic unit 200 is also specifically designed with a thermal management strategy. In particular, the dual-tier arrangement enables a stratified passive thermal management approach optimized for each tier's thermal characteristics.

The upper tier (logic and distribution layer) has the following thermal characteristics: low to moderate power dissipation (typically 20-35 W total); power distribution unit generates minimal heat through efficient voltage regulation; natural convection through perforated mounting surfaces and tier walls; component spacing optimized for airflow between heat-generating elements; thermal rise directed upward and away from the tier; benefits from positioning in cooler air above motor controller.

The lower tier (motor drive layer) has the following thermal characteristics: higher power dissipation concentrated in motor controller (e.g. 50-200 W peak); thermal interface materials between motor controller and structural mounting plate; conductive heat path through mounting plate to main chassis structure; chassis acts as extended heat sink with large surface area exposure to ambient air; benefits from chassis-level cooling systems without requiring dedicated cooling fans; heat source isolated at bottom tier, preventing thermal impact on logic components above.

The thermal stratification naturally creates a temperature gradient, with the coolest region at the upper tier where temperature-sensitive digital components reside, and the warmest region at the lower tier where heat-tolerant power electronics are positioned. This arrangement prevents heat from motor drive electronics from affecting logic system operation or reliability.

The retractable electronic unit 200 is also designed with the retraction mechanism and serviceability in mind. Both tiers are mounted to a unified structural framework that rides on heavy-duty ball-bearing slides, e.g. rated for minimum 50,000 extension cycles. The slides provide an extension travel (e.g. up to 300 mm) with a designed (e.g. 150%) extension capability relative to the electronic unit's installed depth, allowing the entire electronic assembly to be fully withdrawn from the robot chassis.

Various features to improve serviceability may also be incorporated into the retractable electronic unit, such as: tool-less quick-disconnect connectors at the energy chain interface; color-coded and keyed connector systems preventing incorrect reassembly; mechanical detents at different (e.g. 0%, 50%, and 100%) extension positions for stable working configurations; integrated cable management routing between tiers via protected pass-through channels; independent tier access via removable top and bottom covers without full extraction; standardized mounting interfaces enabling component replacement with minimal tools; single-person extraction and installation capability; retraction stop mechanism preventing accidental over-extension; and locking mechanism securing unit in retracted position during robot operation. It will be appreciated that one or more of these features may be incorporated into the retractable electronic unit, and that these features are non-limiting and other features may be implemented as well.

FIG. 2C shows example retractable electronic unit operational states and thermal management features.

The extension travel (which may vary depending on the application, but may for example be 300 mm), enables multiple service positions. Different positions of the electronic unit are possible, including an extension travel position where the telescopic rails are extended a distance 230, a partial extension position where the telescopic rails are extended a 240, and a retracted position 250 where the telescopic rails are not extended. FIG. 2C provides a comparative view showing the electronic unit in the retracted position (left) and a fully extended maintenance position (right). The extension travel provides complete access to both electronic tiers. Chassis-mounted cooling fans 222 are shown that may be incorporated on the chassis in association with the electronic unit, and airflow direction 224 are indicated, demonstrating the integrated thermal management system that complements the electronic unit's passive cooling design.

The retracted position (0 mm extension) is a normal operational configuration, with the electronic unit fully enclosed within chassis of the collaborative mobile robot. The retracted position provides maximum protection from environmental contamination and optimal thermal coupling to chassis heat sink. The retracted position is also a locked position for mobile operation.

The partial extension position (e.g. a 150 mm extension, part-way between the retracted position and extended position) is a quick-access maintenance position. The upper tier components are fully accessible in this position, and the energy chain remains within recommended bend radius. The partial extension position may for example be suitable for software updates, diagnostics, and minor repairs, and provides a stable working position with mechanical detent.

The full extension position (e.g. a complete 300 mm extension of the telescopic rails) is a position that provides complete service access to all components on both tiers and allows for independent cover removal to enable isolated tier servicing. The energy chain is fully extended for maximum cable service loop. The fully extended maintenance position is suitable for component replacement, deep troubleshooting, and modifications, as the electronic unit is completely clear of chassis constraints.

Consistent with the foregoing, the interface between tiers may incorporate several other important features, including but not limited to:
Electrical Interface: High-current power conductors from upper tier power distribution unit to lower tier motor controller; Filtered feed-through connectors with integrated EMI suppression; Segregated power and signal conductor routing to minimize crosstalk; Star-point grounding topology to eliminate ground loops; Shielded cable assemblies for motor control signals;
Mechanical and Thermal Interface: Structural mounting plate providing rigidity and tier separation; Thermal break insulators preventing direct heat conduction from lower to upper tier; Controlled apertures for cable routing while maintaining tier isolation; Electromagnetic shielding continuity across tier boundary through conductive gaskets; Captive fastener design for cover retention during field maintenance;
Cable Management: Protected cable channels routing power and signal conductors between tiers; Strain relief at entry and exit points preventing connector stress; Service loop accommodation for tier-to-tier cabling during full extension; Organized bundle routing preventing cable interference during retraction cycles; Cable tie-down points maintaining routing integrity;
The electronic unit's passive cooling approach also offers several advantages over active cooling systems, including: elimination of fan failure modes within the electronic unit (because there are no moving parts), reduced acoustic signature during operation; zero maintenance requirements for electronic unit cooling system components; improved reliability through simplification and reduced component count; dust and contaminant resistance (there is no forced air drawing particles through electronics); power efficiency (because there is no parasitic load from dedicated cooling fans), and operational continuity independent of active cooling system status.

The passive thermal design is validated through conservative component derating, thermal modeling, and extensive testing across the operational temperature range. All electronics operate within manufacturer-specified temperature limits across the full operational envelope, with thermal margins maintained for long-term reliability.

While the retractable electronic unit 200 employs passive cooling internally, it may interface with the robot's chassis-level thermal management system. The chassis may incorporate strategically positioned cooling fans 222 that create ambient air circulation throughout the robot's interior volume. This circulation provides general temperature control for the entire robot cavity, assists convective heat transfer from the electronic unit's exposed surfaces and perforations, prevents thermal stratification and localized hot-spot formation, operates independently of electronic unit retraction state, maintaining thermal management during service operations, and supplements the electronic unit's passive thermal design without creating dependency.

The electronic unit's lower tier mounting interface may include thermal conduction paths to the chassis structure, allowing chassis mass to act as a heat sink even when the unit is fully retracted for maintenance. The upper tier benefits from natural convection and the cooler ambient air maintained by chassis-level ventilation.

This tiered architecture of the retractable electronic unit 200 in this exemplary configuration provides measurable improvements in maintainability metrics and operational reliability, including:

### Serviceability Metrics:

Mean Time to Repair (MTTR) can be reduced by approximately 65% versus integrated electronic designs;
Component replacement is achievable without specialized tools, training, or cleanroom environment;
Parallel maintenance operations are possible (e.g. upper tier software update concurrent with lower tier inspection);
Field serviceability is possible without factory return for majority of failure modes; and Reduced spare parts inventory through standardized modular components.

### Reliability Improvements:

Mean Time Between Failures (MTBF) is improved through passive cooling reliability and thermal isolation;
Enhanced diagnostic capability via independent tier testing and access;
Extended component lifespan due to optimal thermal conditions and physical protection;
Reduced electromagnetic interference through spatial separation of noise sources and sensitive circuits;
Improved power quality for logic systems through isolation from motor drive switching transients;
Operational Benefits:

Reduced robot downtime through rapid component access and replacement;
Lower total cost of ownership through decreased service requirements;
Enhanced troubleshooting through logical component grouping and accessibility;
Flexibility for future upgrades through modular architecture;
Standardized service procedures across robot fleet;
The retractable dual-tier electronic unit thus represents a fundamental advancement in mobile robot serviceability, transforming what traditionally requires factory return and extended downtime into routine field-serviceable maintenance operations.

The combination of functional layer segregation into different tiers separated by a structural mounting plate, passive thermal management, and drawer-style accessibility enables technicians to perform comprehensive electronic system service without specialized facilities, while the stratified architecture ensures optimal electrical and thermal performance for long-term reliability.

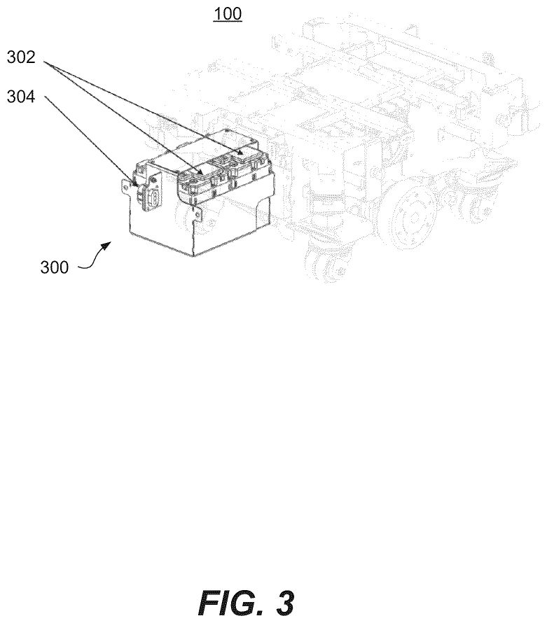

FIG. 3 shows a replaceable and swappable battery module 300 of the CMR 100. Recognizing the importance of uninterrupted operation, the CMR 100 may be equipped with a swappable battery module 300. A battery 302 can be easily accessed and replaced by sliding the battery module 300 out from a rear or side of the robot. This design enables operators to quickly swap batteries during extended operations, minimizing downtime and maintaining continuous functionality in high-demand environments.

The battery 302 may be located at a rear or side of the robot and can be swiftly accessed and replaced. A removable side panel/door of the CMR 100 can provide access to the replaceable battery module 300. The battery module 300 may be pushed to insert the battery module and supported by the chassis. The battery module 300 also comprises a connection port 304.

The replaceable battery module 300 is especially useful for prolonged operations, allowing the CMR 100 to continue functioning without interruption, as batteries can be swapped out quickly when power runs low.

As also depicted in FIG. 1B, the CMR 100 may be provided with a wireless charging unit 110 at the bottom of the chassis. This allows the robot to automatically charge the battery without the need for manual intervention. By using a wireless charging system, the CMR 100 can continuously operate, minimizing downtime and ensuring maximum efficiency during operation. This feature is particularly beneficial in fast-paced industrial settings where manual recharging could disrupt workflow.

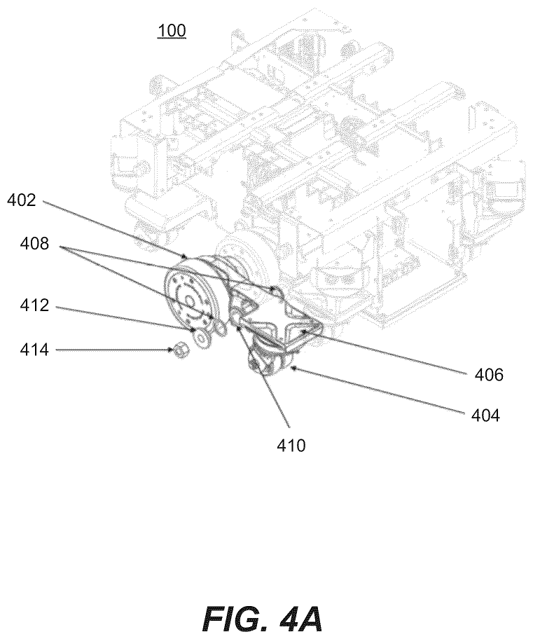

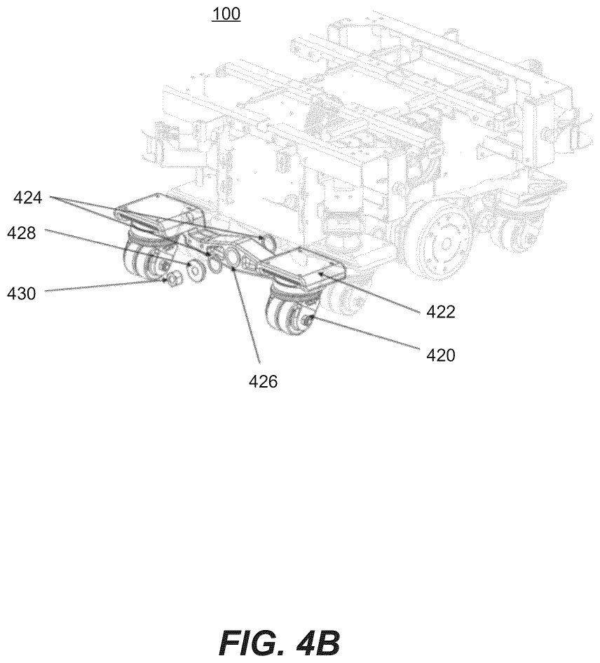

FIGS. 4A and 4B show front and rear perspective views respectively of a rocker-based mobility system of the CMR 100. As depicted in FIG. 1B, the CMR 100 comprises drive train units 114. These drive train units 114 may comprise a rocker-based mobility system, as shown in FIGS. 4A and 4B, which helps the CMR 100 to navigate different terrains. FIG. 4A shows a front perspective view of the CMR 100 highlighting a front drive train, and FIG. 4B shows a rear perspective view of the CMR 100 highlighting a rear drive train.

Referring to FIG. 4A, the CMR 100 may comprise two front rockers (one of which is shown in FIG. 4A), each incorporating a drive wheel 402 and a caster wheel 404. A drive motor is coupled to the drive wheel 402, which is mounted on one end of a rocker arm 406, while the caster wheel 404 is mounted on the other end. The rocker 406 is coupled to a rocker shaft, which may be mounted on the chassis, using thrust washers 408, a sleeve bearing 410, a flange bush 412, and a lock nut 414.

Referring to FIG. 4B, the CMR 100 may have a single rear rocker equipped with caster wheels. Each caster wheel may be mounted at one end of the rocker arm. FIG. 4B illustrates a rear caster wheel 420 attached to a rocker arm 422. The rocker is coupled to a rocker shaft, which may be mounted on the chassis using thrust washers 424, a sleeve bearing 426, a flange bush 428, and a lock nut 430.

Accordingly, the rocker-based mobility drive system shown in FIGS. 4A and 4B helps to reduce vibrations and ensure smooth, stable motion of the CMR 100, even over uneven surfaces. The modularity of the drive train units also ensures that they can be easily replaced without dismantling the entire robot, reducing maintenance time significantly.

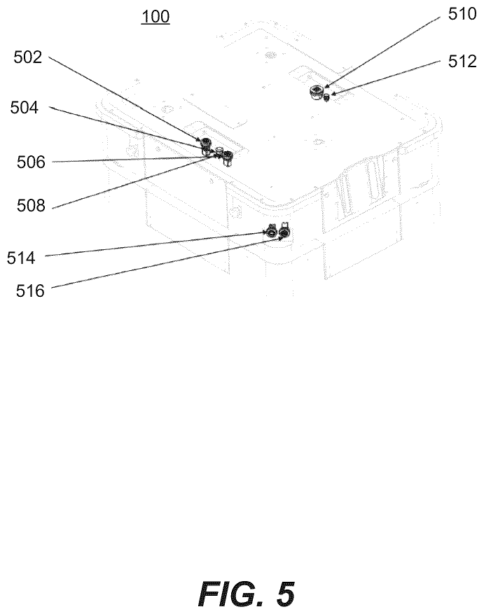

FIG. 5 shows external attachment ports and service ports of the collaborative mobile robot. As described above, the CMR 100 may have various external attachment ports and service ports.

In particular, to enhance the robot's versatility, the CMR 100 may include a range of service and external attachment ports, all designed for easy access. These ports provide a standardized interface for attaching custom hardware, such as USB, Ethernet, and antenna connections, allowing for seamless integration of additional hardware or external sensors, and making it easy to reconfigure the robot for various tasks. The service ports may be available for connecting diagnostic tools or other systems, ensuring that the robot can be quickly serviced or upgraded as needed.

FIG. 5 shows examples of external attachment ports and service ports located on the chassis and/or panels of the CMR 100. The ports depicted in FIG. 5 include an external attachment Ethernet port 502, an external attachment emergency switch port 504, an external attachment USB port 506, an external attachment antenna port 508, an external attachment power port 510, an external attachment light extension port 512, a service Ethernet port 514, and a service USB port 516.

These connections/ports allow for seamless integration with additional hardware such as robotic arms, sensors, or external tools. The service ports provide operators with easy access for diagnostics, software updates, and communication with external systems, enhancing the robot's adaptability and functionality across a variety of tasks.

The external attachment ports thus provide the capability to interface with other tools or systems, enabling the CMR 100 to take on multiple roles, from transporting materials to performing precision assembly tasks. The combination of external attachment and service ports ensures that the CMR 100 can easily adapt to new tasks, enhancing its flexibility and long-term usability.

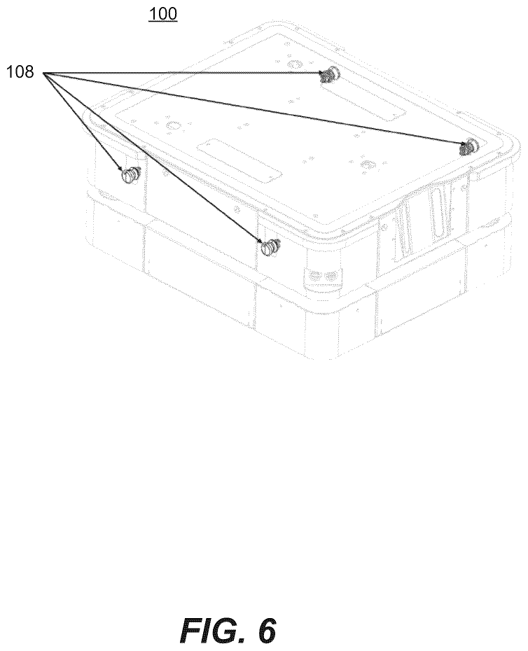

FIG. 6 shows emergency safety features of the CMR 100. The safety of operators is a priority in the design of a CMR. The CMR 100 may comprise one or more emergency stop switches provided on the chassis. In FIG. 6, the CMR 100 is equipped with four strategically placed emergency stop switches 600—one at each corner—ensuring that operators can quickly halt the robot's operation in case of an emergency. These switches are easily accessible and highly visible, ensuring immediate action can be taken in high-risk environments. This feature is designed to protect both operators and the robot in high-risk industrial environments where immediate action may be required.

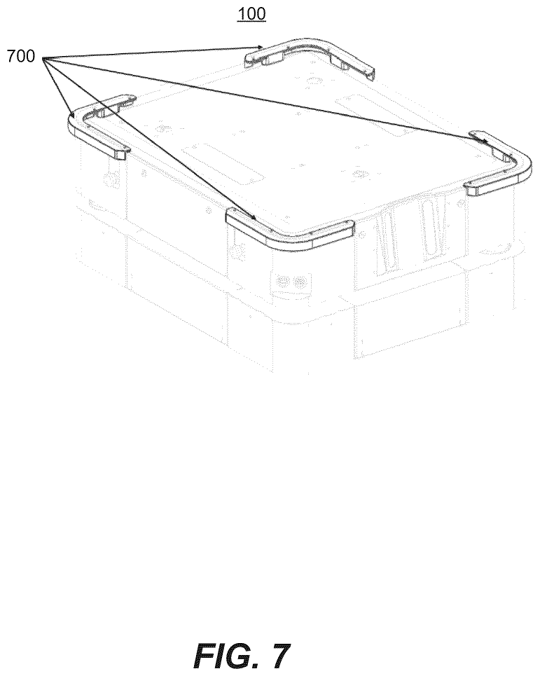

FIG. 7 shows corner bumpers 700 of the CMR 100. The CMR 100 may be equipped with one or more corner bumpers 700 made of a shock-absorbing material to protect against accidental impacts, safeguarding both the robot and its surroundings.

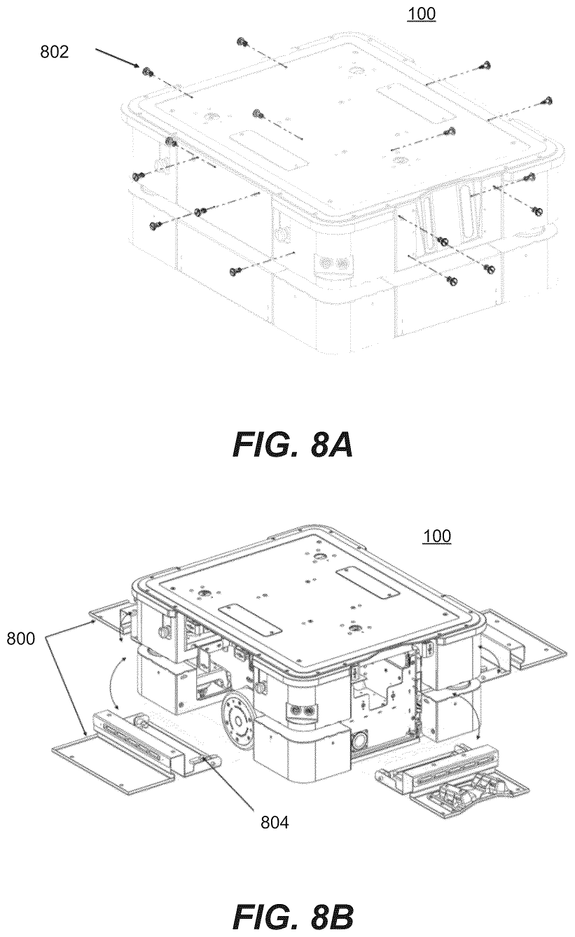

FIGS. 8A and 8B show removable side panels/doors 800 of the CMR 100. The CMR 100 may have removable side doors on one or more sides, allowing quick and easy access to internal components for maintenance. These doors are designed to be easily removed, ensuring that technicians can service the robot efficiently by enabling repairs or adjustments to be made without requiring the entire system to be disassembled, and thus reducing maintenance time and minimizing operational disruptions.

The side doors may be fastened in place using one or more fasteners. FIG. 8A shows fasteners 802 being removed from the side doors. FIG. 8B shows the side doors 800 removed from the chassis. A hinge lock 804 may be provided on each side door 800 to secure the door in place.

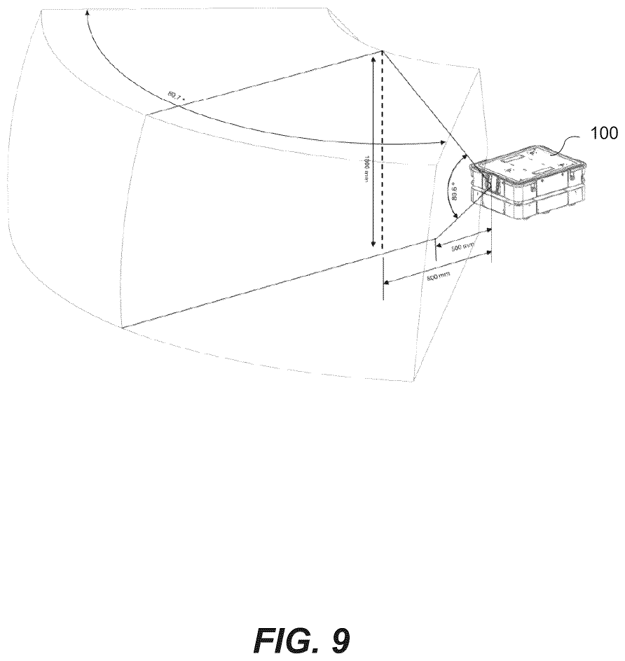

FIG. 9 shows a representation of a field of view for 3D cameras of the CMR 100. As depicted in FIG. 1A, the CMR 100 may comprise a 3D camera module. The CMR may be equipped with one or more 3D cameras to ensure precise navigation and obstacle detection. The cameras enable enhanced visual awareness, ensuring the robot can safely interact with its surroundings and avoid potential hazards.

FIG. 9 shows representation of a field of view for two 3D cameras mounted on the CMR 100. In an embodiment, the cameras may for example provide visual coverage up to 1800 mm above the floor, with a horizontal field of view (FOV) of 89.7° and a vertical FOV of 80.6°. This broad field of vision ensures that the CMR 100 can effectively monitor its surroundings, detect obstacles, and navigate safely in dynamic environments.

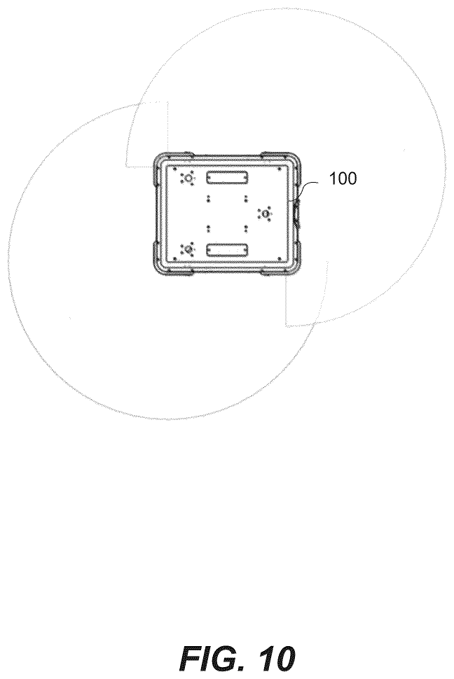

FIG. 10 shows a representation of 360° coverage of safety laser scanners of the CMR 100. As depicted in FIG. 1B, the CMR 100 may comprise safety laser scanners 112. The CMR 100 may be equipped with one or more safety laser scanners to ensure precise navigation and obstacle detection. The laser scanners can provide real-time mapping of the environment, detecting obstacles and adjusting the robot's path accordingly

FIG. 10 shows a 360° coverage provided by two safety laser scanners on the CMR 100. The laser scanners map the robot's environment in real time, detecting obstacles in all directions and ensuring the robot's safe movement. This coverage is important for the robot's ability to operate autonomously in industrial settings, where precision navigation is essential to avoid collisions and perform tasks efficiently.

Accordingly, the CMR in accordance with the present disclosure is designed to be a versatile, reliable, and easy-to-use solution for a wide range of industrial applications. Its modular design, flexibility, and safety features make it stand out among modern mobile robots. There are several key advantages that can be applied in different industries, including but not limited to advantages as outlined below.

Modularity and Flexibility: The CMR's modular design allows it to easily adapt to various tasks by attaching different modules depending on what needs to be done. From material transport to precision assembly, the robot can be quickly reconfigured without requiring extensive changes. This flexibility ensures that the robot can switch tasks seamlessly, reducing the need for separate machines for each job.

Easy Maintenance and Quick Servicing: Serviceability is a key feature of the CMR. The robot's electronics are housed in a retractable unit that slides out for easy access, meaning technicians can quickly service or replace components when needed. Similarly, the replaceable battery module can slide out from the back or side, making it easy to swap for a fully charged battery without disrupting operations.

Wireless Charging for Continuous Operation: The CMR has a wireless charging pad at its base, allowing it to recharge without any manual intervention. This feature is important for industries that need the robot to operate continuously with minimal downtime. It can be programmed to charge itself during breaks in the work schedule, keeping productivity high.

Smooth Mobility and Stability: Equipped with a rocker-based drive system, the CMR can move smoothly across different terrains. The design includes three rockers—two at the front and one at the back—with drive wheels and castors that allow it to handle uneven surfaces with ease. This stability is particularly useful for factories and warehouses, ensuring smooth operations without getting stuck or disrupted by floor variations.

Built-In Safety Features: Safety is an important priority in the design of the CMR. Each corner of the robot may be equipped with emergency stop switches that are easily accessible in case of an emergency. The robot also features corner bumpers that help protect both the robot and its surroundings from accidental impacts. These safety measures give operators peace of mind, especially in environments where quick response is critical.

Future-Proof Design: The CMR is built with future expansion in mind. It features multiple external attachment ports that allow for easy integration with additional hardware or sensors. As industries evolve and new technologies are developed, the robot can be upgraded without needing to be completely replaced. This future-proof design adds long-term value and ensures the robot remains a relevant tool as needs change over time.

It will be appreciated that the CMR described herein can be used in various industries for various applications, including but not limited to the following applications.

Material Handling and Transportation: The CMR's mobility and adaptability make it ideal for transporting materials in factories, warehouses, and logistics centers. It can carry loads, transport goods between workstations, and even handle pallets with the appropriate attachments. This flexibility reduces the need for specialized transport robots.

Precision Assembly and Manufacturing: In industries requiring high precision, such as electronics or automotive manufacturing, the CMR can be equipped with specialized tools to assist in assembling products with great accuracy. Its modular design allows it to switch between different assembly tasks quickly, streamlining production.

Warehouse Automation: Large warehouses can benefit greatly from the CMR's ability to move goods autonomously. Whether it's organizing inventory, transporting products, or restocking shelves, the robot can help automate repetitive tasks, freeing up human workers for more complex duties. The wireless charging feature ensures that the robot can operate continuously with minimal downtime.

Healthcare and Laboratory Use: In healthcare environments, the CMR can transport medical supplies, deliver lab samples, or assist with hospital logistics. Its safety features and smooth movement make it a reliable tool in environments where precision and safety are paramount. By automating routine tasks, the robot helps healthcare professionals focus more on patient care.

Outdoor and Hazardous Environments: The rugged design of the CMR, combined with its mobility, makes it suitable for outdoor use or in hazardous environments like construction sites or mining operations. Its ability to carry specialized tools and navigate difficult terrains makes it a valuable tool in industries where human presence might be risky.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A collaborative mobile robot, comprising:
a chassis; and
a retractable electronic unit that is retractably coupled with the chassis, the retractable electronic unit comprising:
an electronic unit housing supporting one or more electrical components;
a cable enclosure housing one or more electrical cables coupled to the one or more electrical components; and
one or more telescopic rails coupled to the chassis and supporting the electronic unit housing thereon.

2. The collaborative mobile robot of claim 1, wherein the retractable electronic unit comprises an upper tier and a lower tier, wherein the upper tier and lower tier are separated by a structural mounting plate.

3. The collaborative mobile robot of claim 2, wherein the upper tier is configured as a logic, communication, and power distribution layer of the retractable electronic unit.

4. The collaborative mobile robot of claim 2, wherein the lower tier is configured as a motor drive and interface layer.

5. The collaborative mobile robot of claim 2, wherein the structural mounting plate provides a conductive heat path from the one or more electrical components to the chassis.

6. The collaborative mobile robot of claim 1, wherein the one or more telescopic rails enable extension of the retractable electronic unit up to a predefined travel distance.

7. The collaborative mobile robot of claim 1, wherein the cable enclosure comprises a plurality of linkages and is arranged at a periphery of the electronic unit housing to minimize cable stress.

8. The collaborative mobile robot of claim 1, wherein the one or more electrical components comprise: a motor controller, a robot computer, and/or a safety programmable logic controller.

9. The collaborative mobile robot of claim 1, further comprising a replaceable battery module.

10. The collaborative mobile robot of claim 1, wherein the chassis comprises one or more removable side doors.

11. The collaborative mobile robot of claim 1, further comprising a drive system coupled to the chassis, the drive system comprising:
a plurality of drive wheels, each drive wheel mounted on a rocker;
a plurality of caster wheels, each associated with a respective drive wheel, with each caster wheel mounted to the rocker of the respective drive wheel; and
a drive motor coupled to each of the plurality of drive wheels.

12. The collaborative mobile robot of claim 11, wherein the drive system further comprises a plurality of caster wheels mounted to a second rocker.

13. The collaborative mobile robot of claim 12, wherein the plurality of drive wheels are arranged at a first side of the chassis, and the plurality of caster wheels mounted to the second rocker are arranged at a second side of the chassis opposite the first side.

14. The collaborative mobile robot of claim 1, further comprising one or more external attachment ports and/or service ports provided in the chassis.

15. The collaborative mobile robot of claim 1, further comprising one or more emergency stop switches.

16. The collaborative mobile robot of claim 1, further comprising one or more corner bumpers.

17. The collaborative mobile robot of claim 1, further comprising a three-dimensional camera.

18. The collaborative mobile robot of claim 1, further comprising a laser scanner.

19. The collaborative mobile robot of claim 1, further comprising a wireless charging unit arranged at a bottom of the chassis.
